(19) United States
(12) Patent Application Publication
(10) Pub. No.: US 2015/0036063 A1
(43) Pub. Date: Feb. 5, 2015

(54) Display Terminal

(71) Applicant: TRULY OPTO-ELECTRONICS LTD., SHAN WEI (CN)

(72) Inventors: Xuejin Chen, Shan Wei (CN); Jianhua Li, Shan Wei (CN); Zhicheng Li, Shan Wei (CN); Jinhong Lin, Shan Wei (CN); Zekui Huang, Shan Wei (CN); Shichu Wang, Shan Wei (CN); Xinjie Xu, Shan Wei (CN); Heng Zhang, Shan Wei (CN)

(21) Appl. No.: 14/183,155

(22) Filed: Feb. 18, 2014

(30) Foreign Application Priority Data
Aug. 5, 2013 (CN) 201310337538.7

(51) Int. Cl. G02F 1/1335; G02F 1/1333

(52) U.S. Cl. CPC G02F 1/133528; G02F 1/13338
USPC 349/12; 349/96; 257/40

(57) ABSTRACT

A display terminal includes a polarizer and a display screen located below the polarizer, where a gap is formed between the polarizer and the display screen. When the display terminal is in an environment with a high light intensity, light passes through the polarizer and enters the display screen. Since the polarizer is dark, in the propagation of the light, the polarizer and the display screen reflect the light incident on their surfaces, and the polarizer absorbs a part of the light incident on its surface and also the light reflected to it by the display screen. When the display terminal does not operate, the screen of the display terminal tends to be black and will not produce glare due to less reflected light.

This application claims the priority of Chinese Patent Application No. 201310337538.7, entitled “DISPLAY TERMINAL”, filed with the Chinese Patent Office on Aug. 5, 2013, which is incorporated by reference in its entirety herein.

### FIELD

The present application relates to the technical field of display, and particularly to a display terminal

### BACKGROUND

At present, there are many types of display terminals, such as a mobile phone, TV, computer, outdoor advertising screen, which have become an inseparable part of people's life. Display terminals not only enrich people's entertainments, but also provide convenient conditions for work, study and so on. In the prior art, the display terminal includes a display screen and a polarizer combined with the display screen. For example, two polarizers are respectively attaches on an upper surface and a lower surface of an LCD (Liquid Crystal Display) screen directly. A polarizer is directly attached on an upper surface of an OLED (Organic Electroluminescence Display) screen.

In order to improve the display effect of the display terminal, it is very important to improve the performance of the display terminal The display effect of the display terminal needs to be improved especially in an environment with a high light intensity.

### SUMMARY

In view of this, the present application provides a display terminal, which improves the display effect of the display terminal in an environment with a high light intensity.

The present application provides technical solutions as follows.

A display terminal includes a polarizer and a display screen located below the polarizer, where a gap is formed between the polarizer and the display screen.

Preferably, the display terminal includes an upper case and a rear cover located at both sides of the display screen respectively, upper case includes a hollow area and a frame surrounding the hollow area, and the polarizer is directly attached to a surface of the frame facing the display screen.

Preferably, the display terminal further includes a touch screen located at a side of the display screen disposed with the polarizer.

Preferably, the polarizer is located between the touch screen and the display screen, the polarizer is directly attached to the touch screen, and a bonding layer is provided between the polarizer and the display screen.

Preferably, the polarizer is located above the touch screen. the polarizer is directly attached to the touch screen, and a bonding layer is provided between the touch screen and the display screen.

Preferably, the bonding layer is a double sided adhesive layer.

Preferably, the display terminal further includes a transparent cover adapted to cover the hollow area of the upper case of the display terminal

Preferably, the polarizer is directly attached to a surface of the transparent cover facing the display screen.

Preferably, the display screen is an LCD screen or an OLED screen.

Preferably, the display terminal is a mobile phone, a computer, a television or an outdoor advertising screen.

In comparison to the prior art, the technical solution provided by the present application has the following advantages.

In the display terminal according to the present application, a gap is arranged between the display screen and the polarizer located above the display screen. When the display terminal is in an environment with a high light intensity, light passes through the polarizer and enters the display screen. Since the polarizer is dark, in the propagation of the light, the polarizer and the display screen reflect the light incident on their surfaces, and the polarizer absorbs a part of the light incident on its surface and also the light reflected to it by the display screen. In comparison to the existing display terminal with the polarizer directly attached to a surface of the display screen, the display terminal according to the present application greatly reduces the light reflected by the display terminal and improves the display effect of the display terminal in the environment with a high light intensity. When the display terminal does not operate, the screen of the display terminal tends to be black and will not produce glare due to less reflected light.

### BRIEF DESCRIPTION OF THE DRAWINGS

For more clearly illustrating embodiments of the present application or the technical solution in the prior art, drawings referred to describe the embodiments or the prior art will be briefly described hereinafter. Apparently, the drawings in the following description are only several embodiments of the present application, and for the person skilled in the art other drawings may be obtained based on these drawings without any creative efforts.

FIG. 1 is a schematic structural view of a display terminal according to a first embodiment;

FIG. 2 is a schematic structural view of another display terminal according to the first embodiment;

FIG. 3 is a schematic structural view of a display terminal according to a second embodiment; and

FIG. 4 is a schematic structural view of another display terminal according to the second embodiment.

### DETAILED DESCRIPTION OF THE EMBODIMENTS

As described in the background, the display effect of the display terminal needs to be improved. The inventor attends to that the display terminal in the prior art includes a display screen and a polarizer located above the display screen, and the polarizer is closely attached to a surface of the display screen and is thin, such that the polarizer and the display screen are equivalent to an integral structure. When the display terminal is in an environment with a high light intensity, light incident on a surface of the polarizer is substantially all reflected by the polarizer, causing a problem that the user can not see the screen of the display terminal clearly, and thus the display effect is low.

In view of this, the present application provides a display terminal to overcome the above problems in the prior art. The display terminal includes a polarizer and a display screen located below the polarizer, and a gap is formed between the polarizer and the display screen.

In the display terminal according to the present application, a gap is arranged between the display screen and the polarizer located above the display screen. When the display terminal is in an environment with a high light intensity, light passes through the polarizer and enters the display screen. Since the polarizer is dark, in the propagation of the light, the polarizer and the display screen reflects light incident on their surfaces, and the polarizer also absorbs a part of the light incident on its surface and the light reflected to it by the display screen. In comparison to the existing display terminal with the polarizer directly attached to a surface of the display screen, the display terminal according to the present application greatly reduces the light reflected by the display terminal and improves the display effect of the display terminal in the environment with a high light intensity. When the display terminal does not operate, the screen of the display terminal tends to be black and will not produce glare due to less reflected light.

The above is the core concept of the present application. In order to make the above object, features and advantages of the present application to be better understood, the specific embodiments of the present application will be further explained in detail in conjunction with the accompanying drawings.

Although many specific details are explained in the following description so as to have the present application to be fully understood, the present application may also be implemented by other ways other than those described herein, which may be modified by the person skilled in the art without departing from the content of the present application. Therefore, the present application is not limited by the specific embodiments disclosed below.

Then, the present application will be described in detail in conjunction with the schematic views. When the embodiments of the present application are described, for ease of illustration, a cross-section view which shows the device structure may not be partly enlarged in accordance with a general proportion, and the schematic views are only examples, which should not limit the scope of protection of the present application. Furthermore, there should be three-dimensional space containing the length, width and depth in actual production.

The First Embodiment

This embodiment provides a display terminal, such as a mobile phone, a computer, a Television and an outdoor advertising screen. Specifically, the computer may be a tablet computer, a laptop and so on. The display screen of the display terminal may be an LCD screen or an OLED screen.

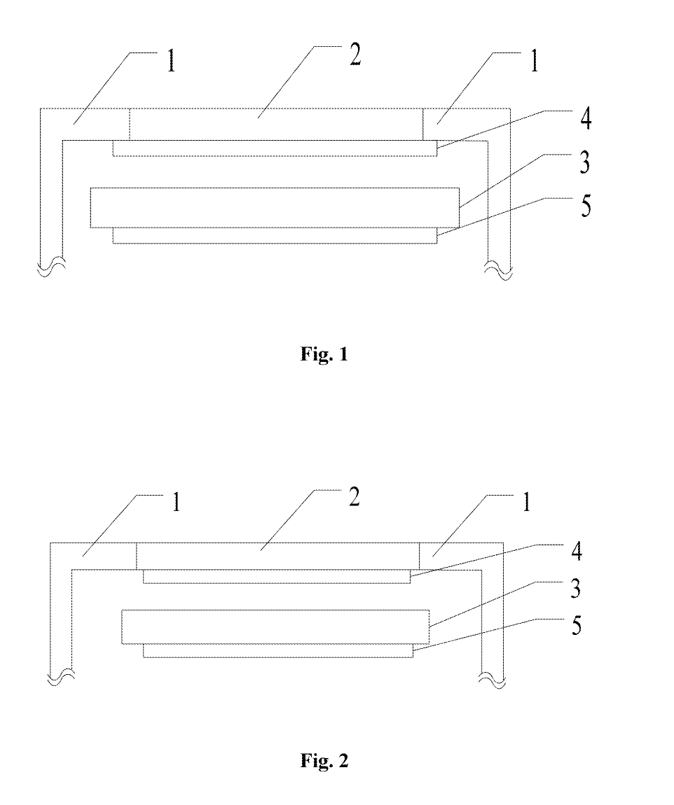

FIG. 1 is a schematic structural view of a display terminal according to the present application. The embodiment is described with a display terminal including an LCD screen. For distinguishing the polarizers of the display terminal including an LCD screen, the polarizer disposed above the LCD screen is called an upper polarizer 4, and the polarizer disposed below the LCD screen is called a lower polarizer 5. The display terminal according to the embodiment includes: an upper case 1; an LCD screen 3; the upper polarizer 4 and the lower polarizer 5. The upper case 1 includes a hollow area and a frame surrounding the hollow area. The display terminal also includes a transparent cover 2 covering the hollow area of the upper case 1. Other components of the display terminal such as a rear cover and a backlight are the same as those in the prior art, thus will not be further described, and are not shown in FIGS. 1-4.

Specifically, the lower polarizer 5 is located below the LCD screen 3 and attached to a surface of the LCD screen 3. The upper polarizer 4 is located above the LCD screen 3, and a gap is formed between the upper polarizer 4 and the LCD screen 3. The display terminal according to this embodiment includes the upper case 1 and the rear cover (not shown) which are located at both sides of the LCD screen 3 respectively. The upper case includes the hollow area and the frame surrounding the hollow area. The polarizer 4 is directly attached to a surface of the frame facing the LCD screen (as shown in FIG. 1).

FIG. 2 is a schematic view of another display terminal according to this embodiment. The display terminal according to the embodiment also includes a transparent cover 2 adapted to cover the hollow area of the upper case 1. The upper polarizer 4 may also be directly attached to a surface of the transparent cover 2 facing the LCD screen 3.

It should be noted that the polarizer has directionality. In the prior art, the upper polarizer (i.e., the polarizer located above the display screen) is attached to the surface of the display screen by attaching a surface of the upper polarizer having viscidity to the surface of the display screen closely, i.e., the surface of the upper polarizer having viscidity faces the display screen. In the present application, since the surface of the upper polarizer having viscidity faces away from the display screen and the surface of the upper polarizer without viscidity faces the display screen, in order to ensure that the upper polarizer works, a difference between a deflection angle of the upper polarizer and a deflection of the upper polarizer in the prior art is 180 degrees. Alternatively, the surface of the upper polarizer having viscidity in the present application needs to be rearranged to be opposite to that of the upper polarizer in the prior art.

Furthermore, for an OLED screen only having one polarizer, the polarizer is located above the OLED screen, and a gap is formed between the polarizer and the OLED screen. The polarizer may also be directly attached to a surface of the frame of the upper case facing the OLED screen in the display terminal, or to a surface of the transparent cover facing the OLED screen, where the transparent cover is adapted to cover the hollow area of the upper case of the display terminal.

In the display terminal according to the present application, a gap is arranged between the display screen and the polarizer located above the display screen. When the display terminal is in an environment with a high light intensity, light passes through the polarizer and enters the display screen. Since the polarizer is dark, in the propagation of the light, the polarizer and the display screen reflects the light incident on their surfaces, and the polarizer absorbs a part of the light incident on its surface and also the light reflected to it by the display screen. In comparison to the existing display terminal with the polarizer directly attached to a surface of the display screen, the display terminal according to the present application greatly reduces the light reflected by the display terminal and improves the display effect of the display terminal in the environment with a high light intensity. When the display terminal does not operate, the screen of the display terminal tends to be black and will not produce glare due to less reflected light.

The Second Embodiment

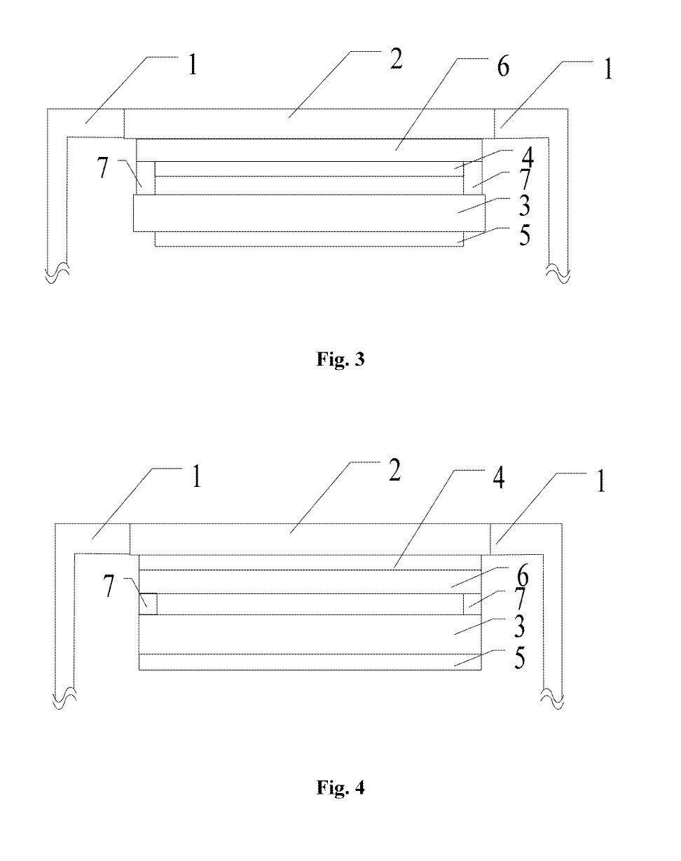

In comparison to the display terminal according to the first embodiment, a display terminal according to this embodiment further includes a touch screen. This embodiment is also described with a display terminal including an LCD screen. That is, a polarizer disposed above the LCD screen is an upper polarizer, and a polarizer disposed below the LCD screen is a lower polarizer. The touch screen and the upper polarizer are located at the same side of the LCD screen. The embodiment will be illustrated in conjunction with FIGS. 3 and 4.

FIG. 3 is a schematic structural view of a display terminal according to this embodiment. The display terminal includes: an upper case 1 of the display terminal; a transparent cover 2 adapted to cover a hollow area of the upper case 1 of the display terminal; an LCD screen 3; an upper polarizer 4 located above the LCD screen 3, where a gap is formed between the upper polarizer 4 and the LCD screen 3; and a lower polarizer 5 located below the LCD screen 3 and directly attached to a surface of the LCD screen 3. In addition, the display terminal also includes a touch screen 6 located at the side of the LCD screen 3 disposed with the upper polarizer 4.

The upper polarizer 4 may be located between the touch screen 6 and the LCD screen 3, and directly attached to the touch screen 6 (i.e., the upper polarizer 4 is directly attached to a surface of the touch screen 6 facing the LCD screen 3). A bonding layer 7 is provided between the upper polarizer 4 and the LCD screen 3. The bonding layer 7 may be an optical adhesive layer adapted to fully attach the upper polarizer 4 to a surface of the LCD screen 3. The bonding layer 7 may also be a double sided adhesive layer, which only bonds a frame of the upper polarizer 4 with the LCD screen 3, or bonds a frame of the touch screen 6 with the LCD screen 3 since the surface of the upper polarizer 4 closely attached to the touch screen 6 is smaller than the surface of the touch screen 6. The bonding layer in the embodiment is preferably a double sided adhesive layer. In comparison to the existing touch screen and the LCD screen bonded with the double sided adhesive layer, the effect caused by an improvement of the arrangement between the upper polarizer and the LCD screen in the present application is significant, i.e., the display effect is enhanced greatly.

FIG. 4 is a schematic structural view of another display terminal according to this embodiment, the display terminal includes: an upper case 1 of the display terminal; a transparent cover 2 adapted to cover a hollow area of the upper case 1 of the display terminal; an LCD screen 3; an upper polarizer 4 located above the LCD screen 3, where a gap is formed between the upper polarizer 4 and the LCD screen 3; and a lower polarizer 5 located below the LCD screen 3 and directly attached to a surface of the LCD screen 3. In addition, the display terminal also includes a touch screen 6 located at the side of the LCD screen 3 disposed with the upper polarizer 4.

The upper polarizer 4 is located above the touch screen 6, and directly attached to the touch screen 6. A bonding layer 7 is provided between the touch screen 6 and the LCD screen 3. The bonding layer 7 is preferably a double sided adhesive layer.

In a display terminal having a touch screen, the polarizer located above the display screen may also be directly attached to a surface of the transparent cover facing the display screen. Alternatively, the polarizer may directly be attached to the surface of the frame of the upper case of the display terminal which faces the display screen. Furthermore, the structure of the LCD screen according to this embodiment is also applicable to the OLED screen.

In the display terminal according to the embodiment, the polarizer is closely attached to the upper or lower surface of the touch screen. Since the polarizer is dark and thin, the touch screen and the polarizer are equivalent to an integral structure. The gap is formed between the touch screen and the display screen, the touch screen is preferably bonded to the polarizer by the double sided adhesive. When the display terminal is in an environment with a high light intensity, incident light passes through the polarizer and the touch screen, and enters the display screen. In the propagation of the light, the polarizer absorbs a part of the light incident on its surface and the light reflected to it by the display screen. In comparison to the existing display terminal with the polarizer directly attached to the surface of the display screen, the display terminal according to the present application greatly reduces the light reflected by the display terminal and improves the display effect of the display terminal in the environment with a high light intensity. When the display terminal does not operate, the screen of the display terminal tends to be black and will not produce glare due to less reflected light.

In addition, in order to achieve the touch function, an electrode pattern is provided on the touch screen. Although the electrode pattern is made of a transparent material, The respective areas of the touch screen does not have an uniform transmission. The polarizer is closely attached to the upper or lower surface of the touch screen, so that the respective areas of the touch screen have an approximated uniform transmission. In this way, the phenomenon that an electrode pattern is appeared due to the uneven transmission of the touch screen in the prior art is avoided.

Based on the above description of the disclosed embodiments, the person skilled in the art may carry out or use the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A display terminal, comprising a polarizer and a display screen located below the polarizer, wherein a gap is formed between the polarizer and the display screen.

2. The display terminal according to claim 1, wherein the display terminal comprises an upper case and a rear cover located at both sides of the display screen respectively, the upper case comprises a hollow area and a frame surrounding the hollow area, and the polarizer is directly attached to a surface of the frame facing the display screen.

3. The display terminal according to claim 1, wherein the display terminal further comprises a touch screen located at a side of the display screen disposed with the polarizer.

4. The display terminal according to claim 3, wherein the polarizer is located between the touch screen and the display screen, the polarizer is directly attached to the touch screen, and a bonding layer is provided between the polarizer and the display screen.

5. The display terminal according to claim 3, wherein the polarizer is located above the touch screen, the polarizer is directly attached to the touch screen, and a bonding layer is provided between the touch screen and the display screen.

6. The display terminal according to claim 4, wherein the bonding layer is a double sided adhesive layer.

7. The display terminal according to claim 2, wherein the display terminal further comprises a transparent cover adapted to cover the hollow area of the upper case of the display terminal

8. The display terminal according to claim 7, wherein the polarizer is directly attached to a surface of the transparent cover facing the display screen.

9. The display terminal according to claim 1, wherein the display screen is a Liquid Crystal Display screen or an Organic Light Emitting Diode screen.

10. The display terminal according to claim 1, wherein the display terminal is a mobile phone, a computer, a television or an outdoor advertising screen.

11. The display terminal according to claim 5, wherein the bonding layer is a double sided adhesive layer.
